(19) United States
(12) Patent Application Publication
(10) Pub. No.: US 2002/0009237 A1
(43) Pub. Date: Jan. 24, 2002

(54) Display reduction method using sub-pixels

(76) Inventors: Tadanori Tezuka, Fukuoka-ken (JP); Hiroyuki Yoshida, Fukuoka-ken (JP); Bunpei Toji, Iizuka Shi (JP)

Correspondence Address: Thomas R. Morrison, Esq., MORRISON LAW FIRM, 145 North Fifth Avenue, Mount Vernon, NY, 10550, US

(21) Appl. No.: 09/906,359

(22) Filed: Jul. 16, 2001

(30) Foreign Application Priority Data
Jul. 21, 2000 (JP) 2000 220042

(51) Int. Cl. G06K 9/32

(52) U.S. Cl. 382/299

(57) ABSTRACT

A display reduction of 1/n is performed with a display device, with which three light-emitting elements, which respectively emit light of the three primary colors of R, G, and B, are aligned in a fixed order to comprise one pixel. A plurality of pixels are aligned in a first direction to form one line. A plurality of lines are aligned in a second direction, orthogonal to the first direction, to comprise the display screen. Original image data is converted to working image data by magnifying or reducing the original data by 3/n in the first direction. The working image data are then allocated to the three light-emitting elements that comprise one pixel and the displayed. The display reduction reduces the loss of information compared to the prior art.

### BACKGROUND OF THE INVENTION

1. Field of the Invention

This invention concerns a method of performing display reduction of 1/n with a display device having an array of light-emitting elements of the three primary colors of R, G, and B.

2. Description of the Related Art

Display equipment that employs various types of display devices has been used in the past. Included among such display devices are color LCD's, color plasma displays, and other display devices, which use three light-emitting elements, respectively emitting light of the three primary colors of R, G, and B. Triads of the three emitters are aligned in a fixed pattern to form one pixel. The pixels are conventionally aligned in a first direction to form one line. A plurality of such lines are aligned in a second direction, orthogonal to the first direction, to complete the display screen.

The problem that arises in the case where a display reduction of 1/n is to be performed using such a display device will now be described based on the example shown in FIGS. 8(a)-8(d). This example concerns a display reduction of ½ in the vertical and horizontal directions.

If the original image is as shown in FIG. 8(a), the image that is reduced by ½ in the horizontal direction is as shown in FIG. 8(b). When the image is further reduced by ½ in the vertical direction, the image is as shown in FIG. 8(c).

An accurate reduction of the original image by ½ should result in the image shown in FIG. 8(d). However, in actuality, the reduced image is as shown in FIG. 8(c). The white portion at the right side of the column, which was contained in the original image, is lost in the reduction process.

Thus with the prior art, there is the problem that when display reduction is performed, part of information in the original image is lost and the display becomes unclear.

### OBJECTS AND SUMMARY OF THE INVENTION

An object of this invention is therefore to provide a display reduction method in which the loss of information is small.

A first mode of this invention provides a method for performing a display reduction of 1/n with a display device, with which three light-emitting elements, which respectively emit light of the three primary colors of R, G, and B, are aligned in a fixed order to comprise one pixel. A plurality of such pixels are aligned in a first direction to form one line of a display. A plurality of such lines are aligned, parallel to each other, in a second direction, which is orthogonal to the first direction, to form the display screen. A display reduction method includes a step in which working image data are determined by magnifying or reducing the original image data by 3/n in the first direction, followed by a step, in which the display device displays upon allocating the working image data to the three light-emitting elements that comprise one pixel.

By this arrangement, the loss of information in the first direction is limited by making use of the correspondence of three light-emitting elements to one pixel in regard to the first direction. As a result, a display that is clear and easy to view is obtained even after reduction.

With a second mode of this invention, the above mentioned working image data are subject to a filtering process, based on factors that are weighed by the degrees of contribution to luminance of the three primary colors, R, G, and B, prior to making the display device perform the display.

Since this arrangement takes into account the degrees of contribution of luminance of the three primary colors R, G, and B, sub-pixel display is performed and color irregularities are restricted further in comparison to the prior art to improve the quality of the sub-pixel display.

With a third mode of this invention, the filtering process is performed in one stage.

Since this arrangement takes into account the degrees of contribution of luminance of the three primary colors R, G, and B, color irregularities are limited adequately even by a single-stage filtering process. Moreover, the processing speed is improved by the simplicity of the process.

With a fourth mode of this invention, the filtering process is performed in two stages.

With this arrangement, the degrees of contribution of luminance of the three primary colors R, G, and B, are taken into account over two stages to enable a fine-tuned filtering process to be performed. Color irregularities are thus further limited, thereby enabling further improvement of the display quality.

With a fifth mode of this invention, at least part of the factors are set so that R:G:B=3:6:1.

By this arrangement, luminance adjustment is performed in a manner that matches the actual circumstances.

With a sixth mode of this invention, the filtering process is performed on a total of three sub-pixels centered about a target sub-pixel.

With this arrangement, since the degrees of contribution of luminance of the three primary colors R, G, and B, are taken into account, color irregularities are limited adequately even by a filtering process performed on a total of three sub-pixels. Moreover, the processing speed is improved by the simplicity of the process.

With a seventh mode of this invention, the filtering process is performed on a total of five sub-pixels centered about a target sub-pixel.

With this arrangement, since the degrees of contribution of luminance of the three primary colors R, G, and B, are taken into account across a wide range and a fine-tuned filtering process is performed, color irregularities are limited further to enable further improvement in the display quality.

With an eighth mode of this invention, an anti-aliasing process is performed in the second direction, after the filtering process and prior to making the display device perform the display.

With this arrangement, jaggedness of the image is made less conspicuous.

With a ninth mode of this invention, the working image data are prepared by magnifying or reducing the original image data by 3/n in the first direction and 1/n in the second direction.

By this arrangement, display reduction of equal rates of reduction in the vertical and horizontal directions is realized with little loss of information.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of the display equipment according to an embodiment of this invention.

FIG. 2 is a flowchart to which reference will be made for explaining the display equipment of an embodiment of this invention.

FIGS. 3(a), (b), and (c) are explanatory diagrams used in explaining the factors used in an embodiment of this invention.

FIGS. 4(a), (b), and (c) are explanatory diagrams used in explaining the factors used in an embodiment of this invention.

FIGS. 5(a), (b), and (c) are explanatory diagrams concerning the factors used in an embodiment of this invention.

FIGS. 6(a), (b), and (c) are explanatory diagrams concerning the factors used in an embodiment of this invention.

FIGS. 7(a), (b), (c), (d), and (e) are explanatory diagrams concerning the process of display reduction by an embodiment of this invention.

FIG. 7(f) is an explanatory diagram of an ideal display reduction.

FIGS. 8(a), (b), and (c) are explanatory diagrams concerning the process of display reduction by a prior art.

FIG. 8(d) is an explanatory diagram of an ideal display reduction.

### DETAILED DESCRIPTION OF THE PREFERRED EMBODIMENTS

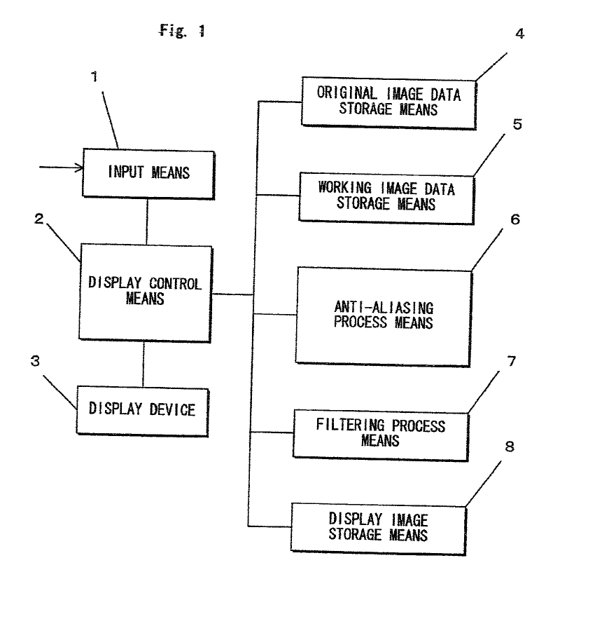

Referring to FIG. 1, an input means 1 inputs information on the operation instructions, etc. A display image storage means 8 (VRAM, etc.) Contains the elements needed for sub-pixel display. A display control means 2 controls the various elements to make display device 3 perform display based on the display image stored in the display image storage means 8.

Display device 3 includes a plurality of sets of three light-emitting elements, which respectively emit light of the three primary colors of R, G, and B. The light-emitting elements are aligned in a fixed order to form one pixel. The pixels are aligned in a first direction to form one line. A plurality of such lines are aligned in a second direction, which is orthogonal to the first direction, to form the display screen. To be more specific, display device 3 may be a color LCD or color plasma display, etc. driven by a driver (not shown) to drive the respective elements of the color LCD or color plasma display, etc.

An original image storage means 4 stores the original image data prior to display reduction. The original image data are raster image data or vector image data that are subsequently developed into raster image data. The original image data may be that of a general image or a font.

In the process of display reduction by display control means 2, a working image data storage means 5 stores a temporary working image, obtained by magnification or reduction of the original image stored in original image data storage means 4.

An anti-aliasing process means 6 performs smoothing of the outlines of a given image.

A filtering process means 7 performs a filtering process, based on factors to be described below, on the working image data stored in working image data storage means 5 and stores the resulting image storage means 8.

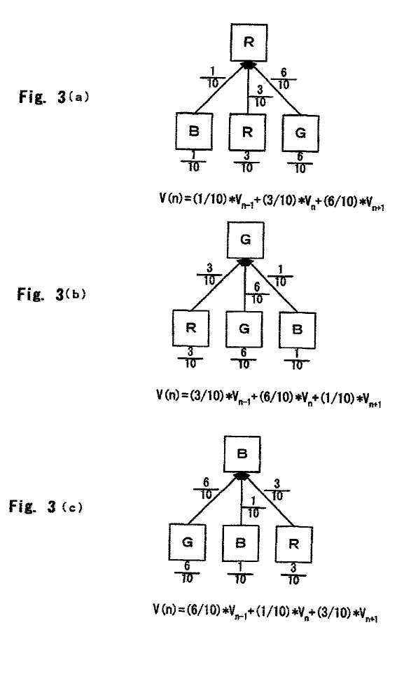

Referring now to FIGS. 3(a)-(c), the factors for a first-stage filtering process are shown for one pixel consisting of the three light-emitting elements (sub-pixels) of R, G, and B. The degrees of contribution to luminance of the subpixels are such that R:G:B=3:6:1.

If as shown in FIG. 3(a), the target sub-pixel is an R sub-pixel, since the sub-pixel to its left is a B sub-pixel and the sub-pixel to the right is a G sub-pixel, energy collection is performed so that, for example, a factor of 1/10 is allocated from the B sub-pixel to the left (one sub-pixel prior to the target sub-pixel, n-1), 3/10 is allocated from the R sub-pixel, which is the target sub-pixel, and 6/10 is allocated from the G sub-pixel to the right (one sub-pixel after the target subpixel, n+1.

Thus if the respective sub-pixel values V are expressed using a suffix, the value V(n) after the degrees of contribution to luminance are taken into account is such that V(n)=(1/10)*Vₙ₋₁+(3/10)*Vₙ+(6/10)*Vₙ₊₁.

Likewise, the filtering process when the target sub-pixel is a G sub-pixel is as shown in FIG. 3(b). The filtering process when the target sub-pixel is a B sub-pixel is as shown in FIG. 3(c).

As is clear from FIGS. 3(a)-(c), if just the factors of the first stage are used, the factors are applied to a total of three sub-pixels centered about the target subpixel.

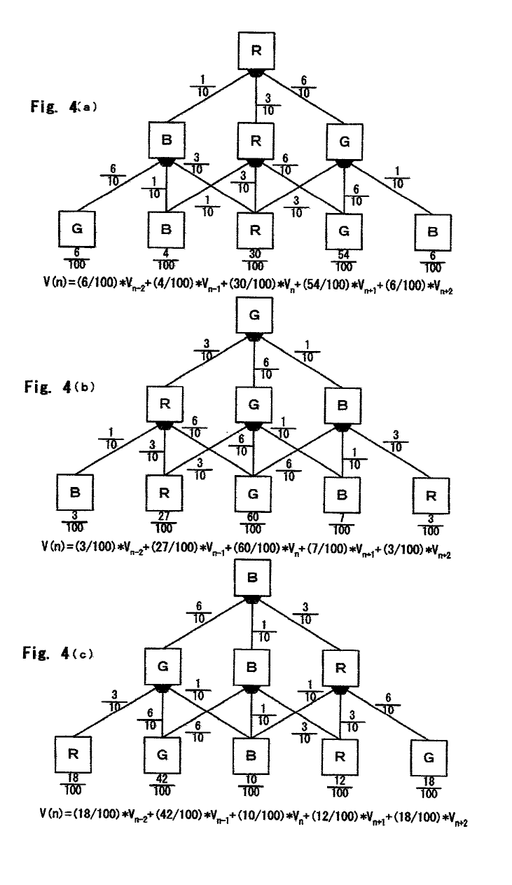

The factors for a second-stage filtering process are described with reference to FIGS. 4(a)-(c). The first stage is exactly the same as that shown in FIGS. 3(a)-(c). Here, when the target sub-pixel is R, since the order of sub-pixels in the stage below the B sub-pixel that branches from the target sub-pixel is GBR as shown in FIG. 4(a), energy collection is performed by allocating factors of 6/10, 1/10, and 3/10 in that order from the left side.

Likewise, since the order of sub-pixels in the stage below the R sub-pixel that branches from the target sub-pixel is BRG, energy collection is performed by allocating factors of 1/10, 3/10, and 6/10 in that order from the left side. Also, for the G sub-pixel that branches from the target sub-pixel, since the order of subpixels in the stage below is RGB, energy collection is performed by allocating factors of 3/10, 6/10, and 1/10 in that order from the left side.

As a result, the hierarchy shown in FIG. 4(a) is formed. With regard to the R sub-pixel (noted sub-pixel, n) at the center of FIG. 4(a), there are three pathways, passing through the B, R, and G sub-pixels, respectively, of the upper stage that lead to this target sub-pixel. The factor for the value V(n) of the target sub-pixel is (1/10)*(3/10)+(3/10)*(3/10)+(6/10)*(3/10)=30/100.

The factor for the other sub-pixels for the lowermost stage are determined in the same manner so that the value V(n) after the degrees of contribution to luminance are taken into account is such that V(n)=(6/100)*Vₙ₋₂+(4/100)*Vₙ₋₁+(30/100)*Vₙ+(54/100)*Vₙ₊₁+(6/100)*Vₙ₊₂.

Likewise, the filtering process when the target sub-pixel is a G sub-pixel is as shown in FIG. 4(b). The filtering process when the target sub-pixel is a B sub-pixel is as shown in FIG. 4(c).

As is clear from FIGS. 4(a)-(c), when factors of two stages are used, the factors are applied to a total of five sub-pixels centered about the target sub-pixel.

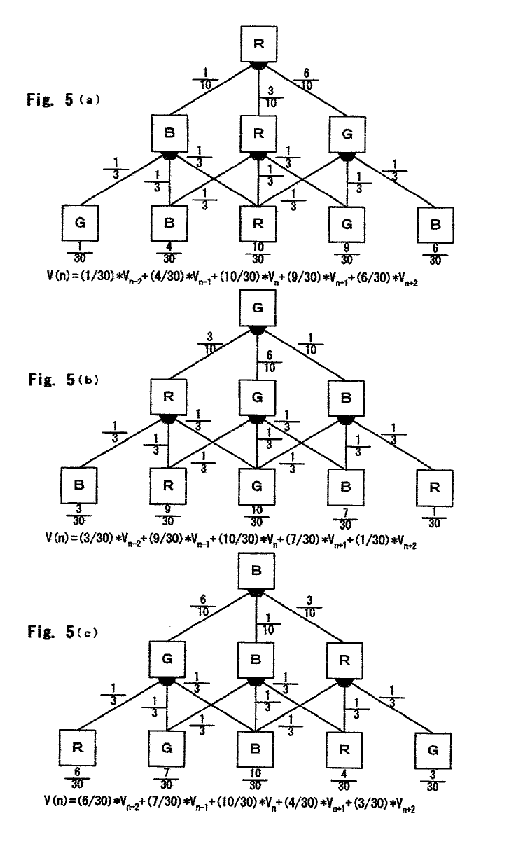

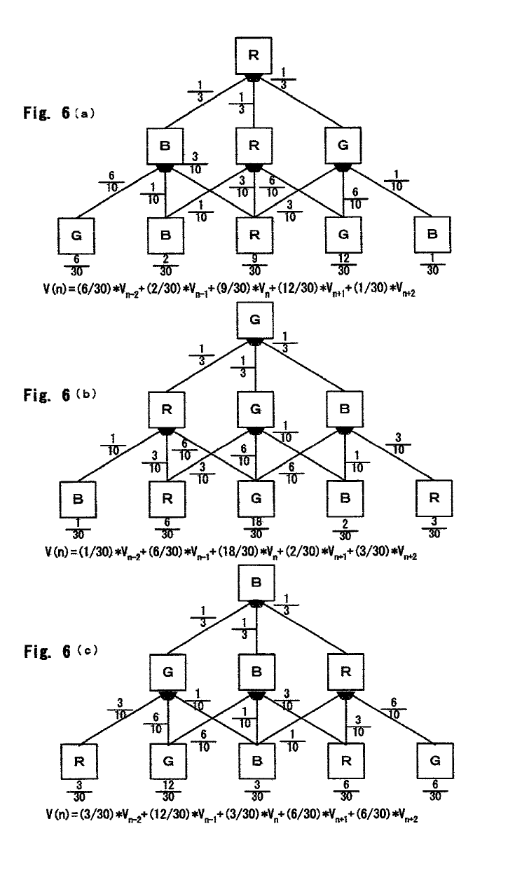

As examples of modifications of the above, those shown in FIGS. 5(a)-(c) (where equal factors of (⅓) are allocated to the second stage) and in FIGS. 6(a)(c) (where equal factors of (⅓) are allocated to the first stage) is given. Even when equal allocation is performed on part of the stages as in these examples, if factors that reflect the degrees of contribution to luminance are used in the other stages, this is adequate for practical purposes in many cases. This invention also includes cases where the above weighting is applied to three or more stages.

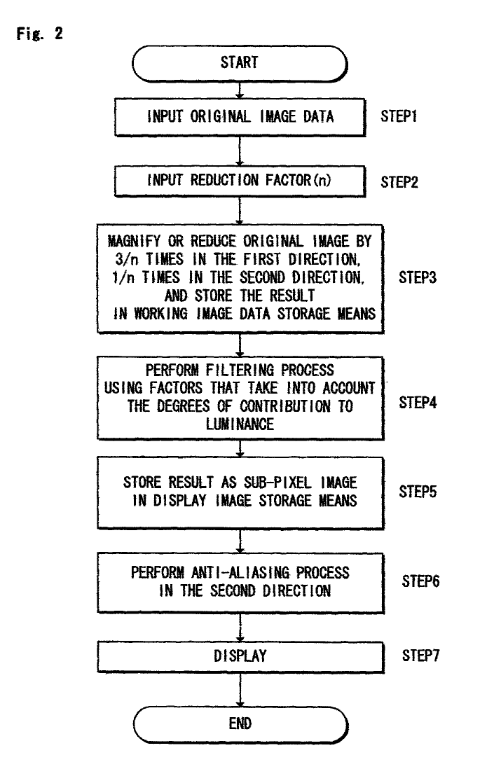

Referring now to the flow chart in FIG. 2, at step 1, the display information indicating that display reduction is to be performed is input to input means 1. The reduction rate (n) is then input from input means 1 (step 2).

Then in step 3, display control means 2 takes the original image data from original image data storage means 4, magnifies or reduces this image by 3/n in the first direction, reduces the original image by 1/n in the second direction, and stores the resulting image in working image data storage means 5. Either direction (vertical/horizontal) may be selected as the first direction of reduction.

Next in step 4, display control means 2 instructs filtering process means 7 to perform a filtering process, using the factors that reflect the degrees of contribution to luminance, on the working image in working image data storage means 5. Here, the factors shown in any of FIGS. 3(a)-(c) to 6(a)-(c) may be used.

When the filtering process is completed, filtering process means 5 returns the processed image data to display control means 2. Display control means 2 stores the received data in display image storage means 8. The storage in display image storage means 8 is not in one pixel units but in units of the three lightemitting elements of R, G, and B that comprise one pixel (that is as a sub-pixel image).

Next in step 6, display control means 2 issues an instruction to antialiasing process means 6 to perform smoothing in the second direction of the subpixel image, stored in display image storage means 8.

Then in step 7, display control means 2 instructs display device 3 to display the image (in the form of sub-pixel display) by allocating the three-times magnified/reduced pattern to the three light-emitting elements that comprise one pixel of display device 3 based on the display image stored in display image storage means 8.

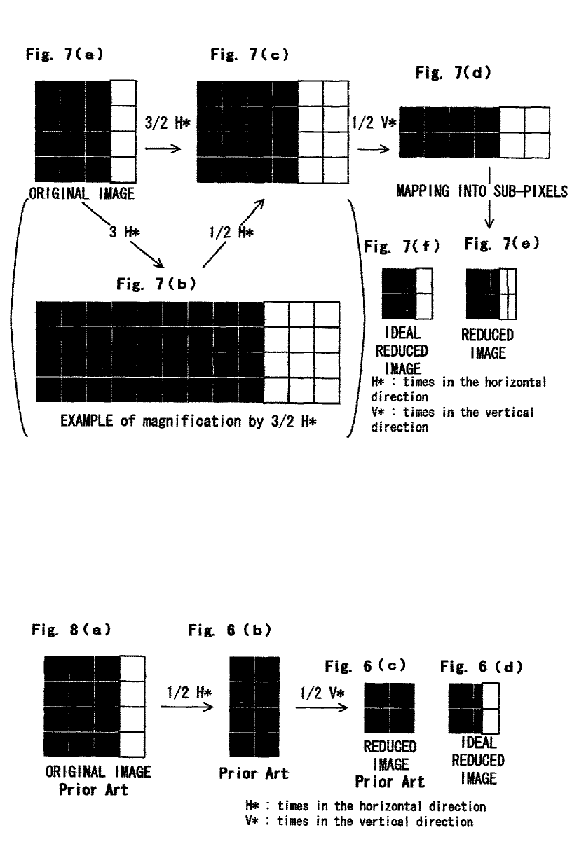

An example of image reduction by the present embodiment will now be described with reference to FIGS. 7(a)-(e). In this example, image reduction is performed under the same conditions (½ in the vertical and horizontal directions) as those of the prior-art example shown in FIG. 8. The first direction is the horizontal direction of FIG. 8 and the second direction is the vertical direction of FIG. 8.

First, the original image is that shown in FIG. 7(a). The original image data for this image are stored in original image data storage means 4. Image control means 2 then reduces this image by ½ in the vertical direction and magnifies this image by 3/2 in the horizontal direction as shown in FIG. 7(d) and stores the resulting image in working image data storage means 5.

In achieving the condition of FIG. 7(d) from that of FIG. 7(a), the condition of FIG. 7(d) is reached via the conditions shown in FIGS. 7(b) and 7(c).

In any case, since the working image data shown in FIG. 7(d) is stored in working image data storage means 5, display control means 2 performs allocation of the working image data of FIG. 7(d) in a manner suitable for sub-pixel mapping and stores the image data of FIG. 7(e) in display image storage means 8. Display reduction, based on a reduced image of sub-pixels, each of which comprises one-third of one pixel, in the first direction (the horizontal direction in this example) is thus performed.

It can be understood that even in comparison to the ideal reduced image shown in FIG. 7(f) the image reduction by this embodiment results in the good image reduction result shown in FIG. 7(e), with which the white part of the row at the right is not lost.

As has been described above, by this invention, the loss of information is limited during display reduction and a reduced display that is easy to view is realized. Also, the filtering factors are arranged to perform high quality display with minimum color irregularities.

Although the invention is described above as controlling R, G and B (red, green and blue) emitters, in some situations, other colors may be selected to produce the desired visual impression. Therefore, the invention should be seen by one skilled in the art to include any combination of color emitters. For example, there may be applications in which only two emitters are required to form a pixel. In other cases, more than three color emitters. For purposes of description, however, the above specification recites the common primary colors of R, G and B colors.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method of performing a display reduction of 1/n with a display device, comprising:
arranging first, second and third light-emitting elements in a predetermined pattern to form one pixel;
said first, second and third light-emitting elements emitting light of first, second and third colors;
driving said first, second and third light-emitting elements with energy effective to produce a visual impression of a desired color;
aligning a plurality of said pixels in a first direction to form one line;
aligning a plurality of said lines in a second direction, orthogonal to said first direction, to form a display screen;
performing a reduction method of one of magnifying and reducing said display by a factor n;
said reduction method including multiplying working image data by 3/n in said first direction; and
allocating said working image data to said first, second and third light emitting elements that make up each pixel.

2. A display reduction method as set forth in claim 1, further comprising:
filtering said working image data;
weighting said filtering in accordance with a degrees of contribution to luminance of said first, second and third colors; and then
displaying weighted colors.

3. A display reduction method according to claim 2, wherein said first, second and third colors are R, G and B.

4. A display reduction method as set forth in claim 2, wherein at least part of said degrees of contribution are R:G:B=3:6:1.

5. A display reduction method as set forth in claim 2, wherein the step of filtering includes filtering in one stage.

6. A display reduction method as set forth in claim 2, wherein the step of filtering includes filtering in at least two stages.

7. A display reduction method as set forth in claim 2, wherein said filtering includes filtering a total of three sub-pixels centered about a target sub-pixel.

8. A display reduction method as set forth in claim 2, wherein said filtering includes filtering five sub-pixels centered about a target sub-pixel.

9. A display reduction method as set forth in claim 2, further comprising anti-aliasing in said second direction after said filtering and prior to said displaying.

10. A display reduction method as set forth in claim 1, further comprising multiplying an original image data by a factor of 3/n in said first direction and 1/n in said second direction to produce said working image data, where n is not equal to zero.

11. A display reduction method for reducing dimensions of a displayed image by a factor of n:
storing an original image data consisting of pixels, each pixel containing three colors;
forming a working image data by multiplying pixels arrayed in a first direction by 3/n, and multiplying pixels in a second direction by 1/n; and
weighting energy of said three colors in each pixel according to three colors in at least two adjacent pixels, whereby the desired display reduction is attained.
